(19) United States
(12) Patent Application Publication
(10) Pub. No.: US 2025/0183450 A1
(43) Pub. Date: Jun. 5, 2025

(54) STAMPED BATTERY HOUSING

(71) Applicants: Theodore GRABOW, Hazel Park, MI (US); Arun Prasath PANDIYAN, Rochester Hills, MI (US); Venugopal GARIMELLA, Troy, MI (US); Sunny KHARBANDA, Rochester Hills, MI (US); MAGNA INTERNATIONAL INC., Aurora (CA)

(72) Inventors: Theodore GRABOW, Hazel Park, MI (US); Arun Prasath PANDIYAN, Rochester Hills, MI (US); Venugopal GARIMELLA, Troy, MI (US); Sunny KHARBANDA, Rochester Hills, MI (US)

(21) Appl. No.: 18/842,919

(22) PCT Filed: Mar. 20, 2023
(86) PCT No.: PCT/US2023/015639

§ 371 Date: Aug. 30, 2024

Related U.S. Application Data
(60) Provisional application No. 63/322,268, filed on Mar. 22, 2022.

(51) Int. Cl. H01M 50/249; H01M 10/613; H01M 10/625; H01M 10/6556; H01M 50/204; H01M 50/224; H01M 50/242; H01M 50/262; H01M 50/276; H01M 50/289

(52) U.S. Cl. CPC H01M 50/249; H01M 10/613; H01M 10/625; H01M 10/6556; H01M 50/204; H01M 50/224; H01M 50/242; H01M 50/262; H01M 50/276; H01M 50/289

(57) ABSTRACT

A battery housing for an automobile includes a lower tub, and an upper cover is disposed on the lower tub to collectively define an internal cavity. At least one battery module is disposed in the internal cavity and enclosed between the lower tub and the upper cover. At least one of the lower tub or the upper cover is formed as a one-piece stamped component. In a preferred arrangement, both of the lower tub and the upper cover of the battery housing are each formed as one-piece stamped components to provide a sealed design for the resultant battery housing.

### CROSS-REFERENCE TO RELATED APPLICATION

This PCT International Patent Application claims the benefit of U.S. Provisional Patent Application Ser. No. 63/322,268, filed on Mar. 22, 2022 and titled a “Stamped Battery Housing,” the entire disclosure of which is hereby incorporated by reference.

### BACKGROUND OF THE INVENTION

### 1. Field of the Invention

The present invention relates to a battery housing for an automobile and a method of manufacturing same.

### 2. Related Art

This section provides background information related to the present disclosure which is not necessarily prior art.

Automobiles are the subject of a continuing effort to move away from internal combustion engines towards electrified vehicles, to reduce their dependency on fuel, improve emissions and increase fuel efficiency. Thus, this desire to increase fuel efficiency is both economically and environmentally motivated and has led to advanced internal components in automobiles as evidenced by developments in batteries, particularly in electrified automobiles. Unlike traditional automobiles that operate entirely with fossil fuels, electrified automobiles include a range of technologies that rely on electric energy. Even though electric energy is a more economical and environmentally friendly option over relying completely on fossil fuels, batteries are heavy, expensive, and relatively fragile compared to neighboring mechanical components. As such, the packaging of batteries, particularly within electrified automobiles, requires a number of design considerations including weight distribution, temperature regulation, and serviceability. In terms of serviceability, there is a growing need, particularly with electrified automobiles, for the batteries to be stowed in such a manner to be charged and maintained without removal.

To meet the above minimum requirements, batteries have traditionally been packaged in protective battery housings. In some cases, these traditional battery housings have been formed from multi-piece aluminum (e.g., a welded structure comprised of multiple aluminum extruded parts or discrete stampings joined together) or SMC plastic materials. However, these exotic, multi-piece aluminum structures and/or requisite SMC materials can be expensive. Furthermore, due to their reduced strength, the battery housing and its associated components, such as the lower tub or upper cover, are often inbuilt with vehicle crash protection structures which deduct volumes for placing battery modules and increase system mass and costs. These additional structural components also lead to complex battery housings with special requirements to meet the requisite performance standards. Accordingly, there remains a continuing need for improved battery housing designs which reduce or eliminate their reliance on multiple parts, such as aluminum extrusions, sheets and SMC materials, for manufacturing components of the battery housing.

### SUMMARY OF THE INVENTION

The subject disclosure is directed to a battery housing including at least a lower tub or an upper cover component formed as a one-piece stamped component. In a preferred embodiment, both the lower tub and the upper cover of the battery housing are each formed as one-piece stamped components to provide a sealed design (i.e., one devoid of welded seams that are prone for leakage) for the resultant battery housing. Stamping these components of the battery housing provides a less complex and more cost effective manufacturing method, namely because a capital reduction is achieved due to elimination of aluminum extrusions or SMC tooling, along with eliminating the need to connect multiple discrete components to form the lower tub and/or upper cover. The stamped lower tub and/or upper cover can also be optimized such that a body of the automobile handles the vehicle crash protection while the battery housing provides the stiffness, fatigue and other load cases required for the battery housing performance, namely to protect the battery modules stored therein. Put another way, cost savings from utilizing a stamped component can be engineering back into the frame structures of the automobile, resulting in optimization of the stamped lower tub and/or upper cover through design changes, such as removal of material or other structure components that would otherwise be required to meet vehicle crash protection for the vehicle. Furthermore, the battery housing including at least one of the lower tub or the upper cover being a one-piece stamped component provides a flexible design that can be quickly adapted to multiple platforms.

### BRIEF DESCRIPTION OF THE DRAWINGS

These and other advantages of the present disclosure will be more readily understood by reference to the following description in combination with the accompanying drawings wherein:

FIG. 1 is a perspective view of a battery housing in accordance with the subject disclosure;

FIG. 2 is an exploded perspective view of the battery housing illustrating a plurality of battery modules and a plurality of cross members disposed in an internal cavity defined by an upper cover and a lower tub each formed as a one-piece stamped component;

FIG. 3 is a partial cross-sectional view of the battery housing of FIG. 1 taken along 3-3 to illustrate one of the plurality of battery modules attached to abase portion of adjacent ones of the plurality of cross members;

FIG. 4 is a bottom perspective view of FIG. 3 illustrating the plurality of battery modules each including a plurality of flanges extending underneath and attached to the base portion of the plurality of cross members via flange fasteners;

FIG. 5 is a partial cross-sectional view of the battery housing of FIG. 1 taken along 5-5 to illustrate a lower tub reinforcement extending within the internal cavity and disposed between a cooling plate and a base surface of the lower tub;

FIG. 6 is a magnified cross-sectional view of a portion of FIG. 1 taken along 6-6 to illustrate a frame for the battery housing formed as a one-piece stamped component in accordance with a first aspect; and

FIG. 7 is an alternative magnified cross-sectional view of the battery housing illustrating the lower tub reinforcement alternatively disposed outside of the battery housing along an exterior, bottom surface of the lower tub and the frame alternatively comprised of a roll formed component in accordance with a second aspect.

### DETAILED DESCRIPTION OF THE ENABLING EMBODIMENTS

Example embodiments will now be described more fully with reference to the accompanying drawings. In general, the subject embodiments are directed to a battery housing for an automobile and a method of manufacturing same. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

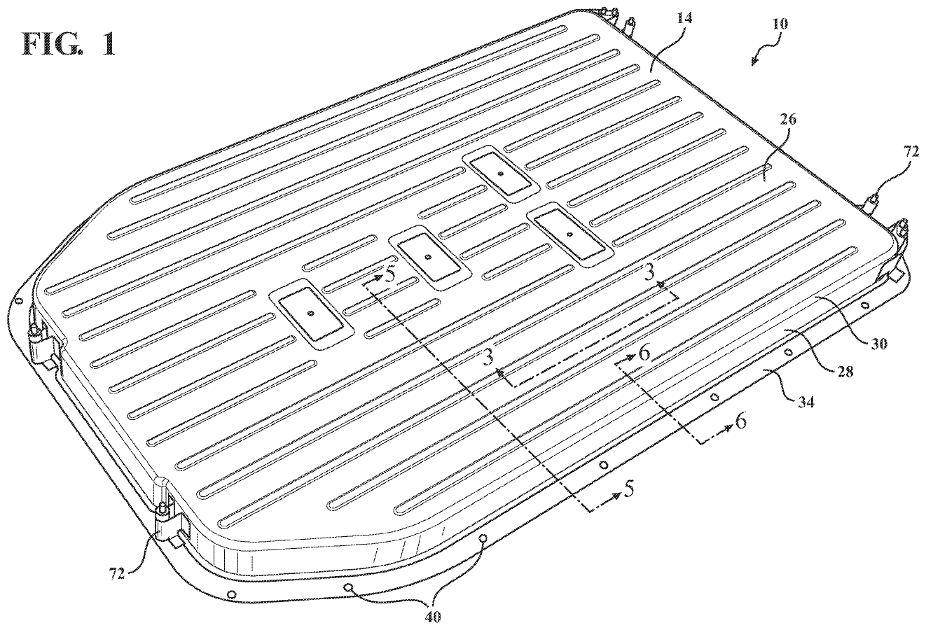

As illustrated in FIGS. 1-3 and 5-7, the battery housing 10 includes a lower tub 12, and an upper cover 14 is disposed on the lower tub 12 to collectively define an internal cavity 16. At least one battery module 18, and preferably a plurality of battery modules 18 are disposed in the internal cavity 16 and enclosed between the lower tub 12 and the upper cover 14 to seal and isolate the plurality of battery modules 16 from an environment of the battery housing 10. At least one of the lower tub 12 or the upper cover 14 is formed from stamping metal, such as steel or aluminum, to provide a one-piece integral component. Put another way, at least one of the lower tub 12 or the upper cover 14 is formed as an integral one-piece stamped component. In a preferred embodiment, both the lower tub 12 and the upper cover 14 of the battery housing are each formed as integral one-piece stamped components. Use of a one-piece stamped lower tub 12 and upper cover 14 eliminates the presence of any leak paths in these components (because a weld is not present and required to form the individual components), and thus provides an improved seal design over the prior art designs which require multiple pieces to form the lower tub and/or the upper cover. As described in the previous section above, use of stamping to form one-piece components for the lower tub 12 and/or the upper cover 14 also reduces complexity of design and related materials.

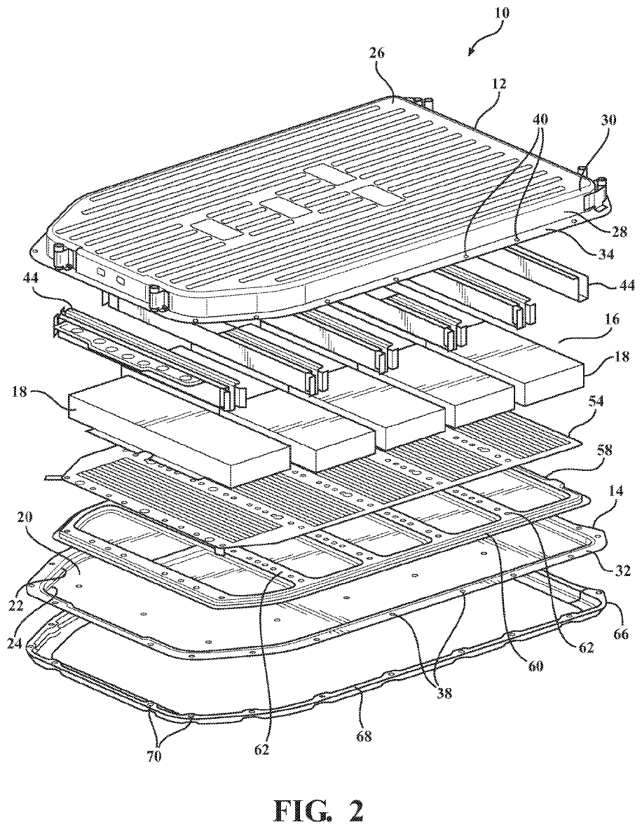

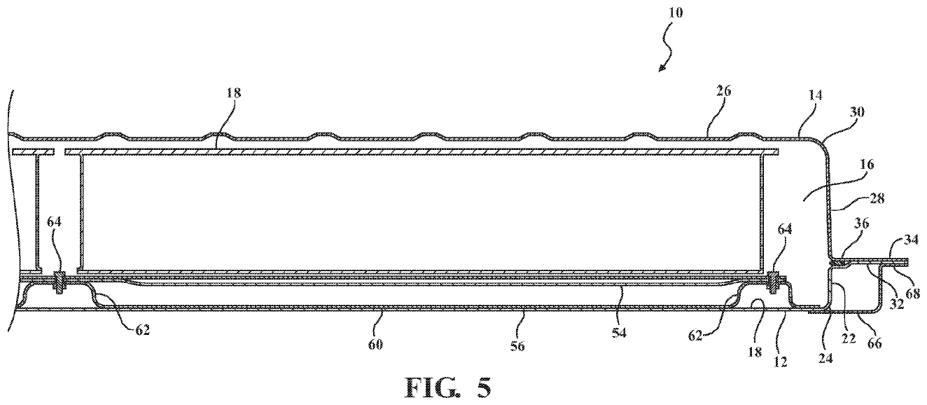

As best illustrated in FIG. 2, the lower tub 12 includes a base surface 20 and a lower sidewall 22 extends upwardly from a peripheral lower edge 24 of the base surface 20. Similarly, the upper cover 14 includes a top surface 26 and an upper sidewall 28 extends downwardly from a peripheral upper edge 30 of the top surface 26. As best illustrated in FIGS. 2-3 and 5-7, the lower tub 12 includes a lower rim 32 extending outwardly from the lower sidewall 22, and the upper cover 14 includes an upper rim 34 extending outwardly from the upper sidewall 28 and which is disposed in overlaying relationship with the lower rim 32 when the upper cover 14 is disposed on the lower tub 12. As best illustrated in FIGS. 5-7, a seal 36 is disposed between the upper rim 34 and the lower rim 32 and preferably extends around the entire perimeter of the battery housing 10 to establish a sealed relationship between the upper cover 14 and the lower tub 12 when these components are interconnected to one another for preventing the passing of contaminants from the environment and into the internal cavity 16 of the battery housing 10.

As illustrated in FIGS. 1-2 and 5-7, in a preferred arrangement, the lower rim 32 defines a plurality of lower apertures 38 disposed in spaced relationship with one another, and the upper rim 34 defines a plurality of upper apertures 40 disposed in spaced relationship with one another and each disposed in aligned relationship with a respective one of the plurality of lower apertures 38. A plurality of rim fasteners 42, such as a paired bolt and nut, are each passed through and secured to a respective pair of the aligned lower and upper apertures 38, 40 to secure the upper cover 14 and the lower tub 12 to one another and enclose the plurality of battery modules 18 within the internal cavity 16. However, the lower rim 32 and the upper rim 34 could alternatively be connected to one another via other means, such as via welding, without departing from the scope of the subject disclosure.

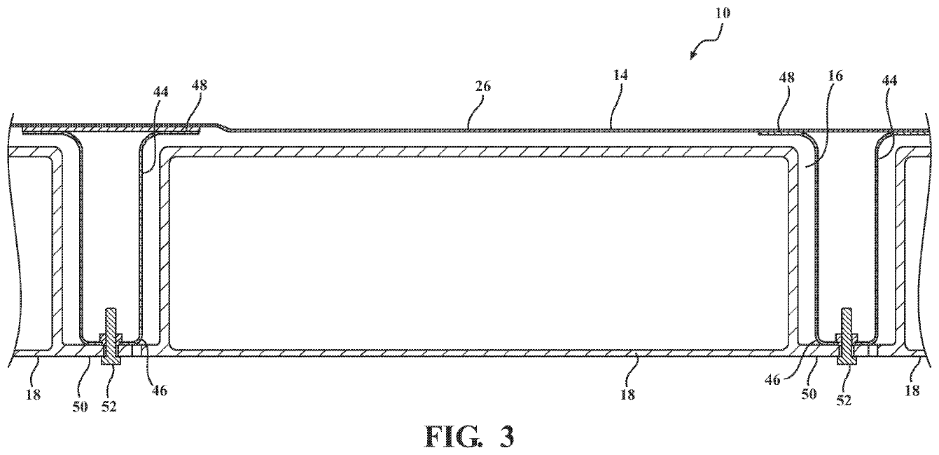

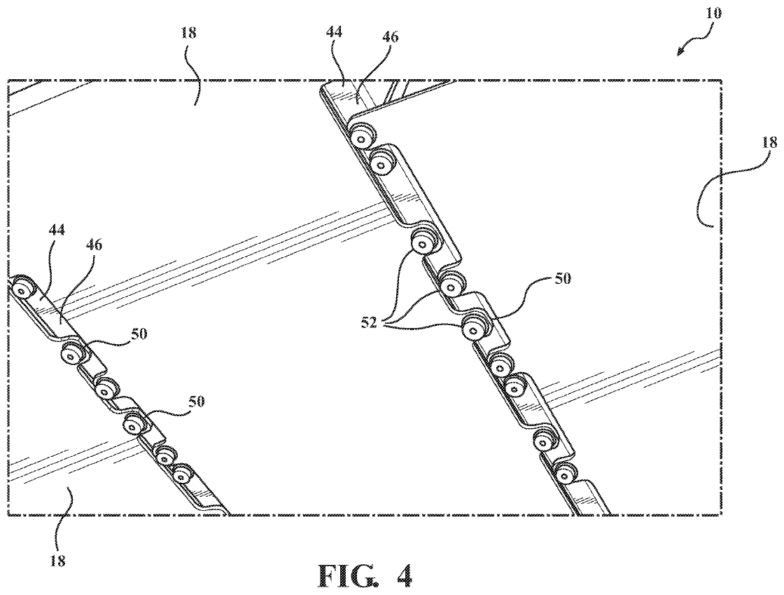

A plurality of cross members 44 are disposed inside the internal cavity 16 and extend transversely between opposing sides of the lower sidewall 22 of the lower tub 12 and the upper sidewall 28 of the upper cover 14 to provide support for the battery housing 10 for crash performance. As best illustrated in FIG. 2, the cross members 32 are preferably disposed between adjacent rows of the plurality of battery modules 18 to also provide support for and absorb side-to-side movement of the battery modules 18 during operation of the battery housing 10. As best illustrated in FIG. 3, each of the cross-reinforcement members are preferably U-shaped when viewed in cross-section along plane 3-3 of FIG. 1 to define a base portion 46 disposed adjacent and arranged generally planar with the base surface 20 and a flanged portion 48 disposed in abutting and underlying relationship with the top surface 36 of the upper cover 14. As further illustrated in FIGS. 3-4, each of the plurality of battery modules 18 are secured to adjacent ones of the plurality of cross members 18, preferably with a plurality of flanges 50 that extend underneath and are attached to the base portions 46 of the adjacent cross members 44 with a plurality of flange fasteners 52.

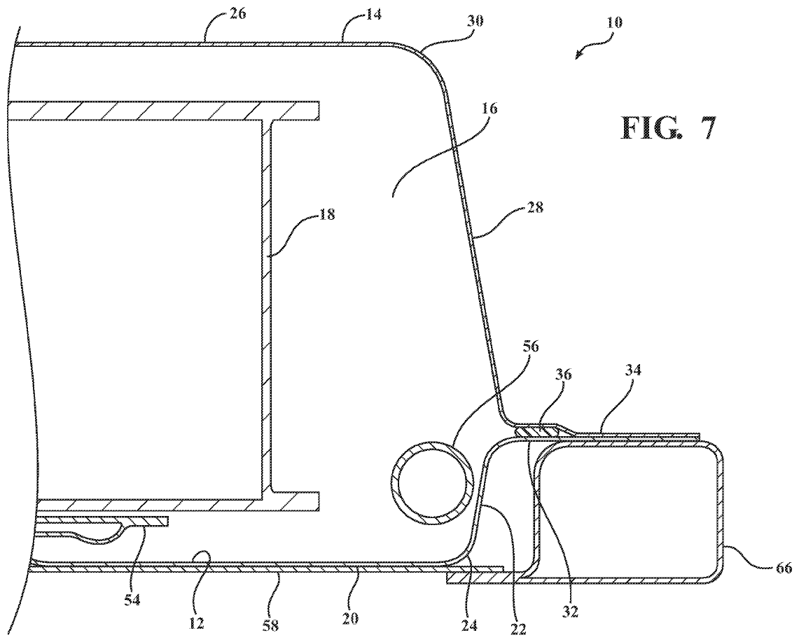

As best illustrated in FIGS. 1 and 5-6, at least one cooling plate 54 is disposed within the internal cavity 16 and extends underneath and preferably in contact with the plurality of battery modules 16 for cooling the battery modules 16 during operation. Although not expressly illustrated, the cooling plate 54 can be connected to a coolant system of the automobile to introduce coolant to the at least one cooling plate 54. As illustrated in FIG. 7, a coolant pipe 56 can extend within the internal cavity 16 and be disposed in fluid communication with the coolant plate 54 to establish the fluid communication between the cooling plate 54 and the coolant system.

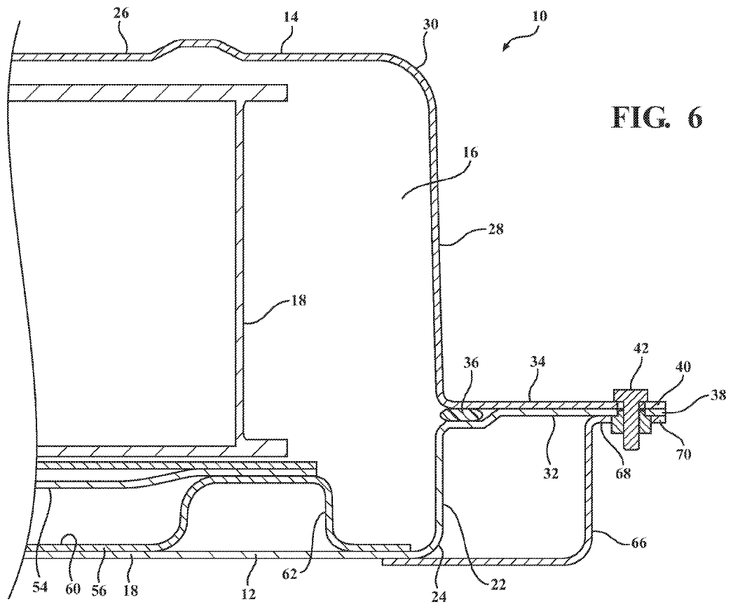

As best illustrated in FIGS. 1 and 5-6, a lower tub reinforcement 58 extends within the internal cavity 16, and is disposed between the cooling plate 54 and the base surface 20 of the lower tub 12, to protect the at least one cooling plate 24 and the plurality of battery modules 16 from a lower impact. However, as best illustrated FIG. 7, the lower tub reinforcement 58 can be disposed outside of the battery housing 10 and extend along an exterior surface of the lower tub 12 without departing from the scope of the subject disclosure. In a preferred arrangement, the lower tub reinforcement 58 is comprised of a reinforcement plate 60 which extends along the base surface 20 of the lower tub 12 and includes a plurality of support members 62 extending upwardly in spaced relationship with one another, each having an inverted U-shaped cross-section. As best illustrated in FIGS. 5-6, the at least one cooling plate 54 extends along and is supported by the plurality of support members 62 to dispose the at least one cooling plate 24 in spaced relationship with the base surface 20 of the lower tub 12. The at least one cooling plate 24 is preferably secured to the plurality of support members 62 via a plurality of plate fasteners 64.

As illustrated in FIGS. 2 and 5-7, the battery housing 10 includes a frame 66 disposed in surrounding relationship with the lower sidewall 22 of the lower tub 12 and extending underneath a portion of the base surface 20 to provide additional structural integrity and protection to the battery housing 10. In a preferred arrangement, the frame 66 is also formed from stamping metal, such as steel or aluminum, to provide a one-piece integral component, and includes a lip 68 which extends and is arranged underneath the lower rim 32. As best illustrated in FIGS. 1 and 6, the lip 68 defines a plurality of lip apertures 70 disposed in spaced relationship with one another and each disposed in aligned relationship with a respective pair of the aligned lower and upper apertures 38, 40. Accordingly, the plurality of rim fasteners 42 additionally pass through respective ones of the plurality of lip apertures 70 to secure the frame 66 to the lower tub 12 and the upper cover 14. However, as illustrated in FIG. 7, in an alternative arrangement the frame 66 can be formed as a roll formed component and secured to the lower tub 12 via spot welding, laser welding, adhesive, riveting or the like. As best illustrated in FIG. 1, the battery housing 10 can include a plurality of body mounts 72 disposed along and outwardly of the upper sidewall 28 of the upper cover 14 for use in mounting the battery housing 10 to a portion of the vehicle.

Obviously, many modifications and variations of the present disclosure are possible in light of the above teachings and may be practiced otherwise than as specifically described.

1. A battery housing for an automobile comprising:
a lower tub;
an upper cover disposed on said lower tub to collectively define an internal cavity;
at least one battery module disposed in said internal cavity and enclosed between said lower tub and said upper cover; and
at least one of said lower tub or said upper cover being formed as a one-piece stamped component.

2. The battery housing as set forth in claim 1, wherein both of said lower tub and said upper cover are formed as one-piece stamped components.

3. The battery housing as set forth in claim 2, wherein both of said lower tub and said upper cover are comprised of steel.

4. The battery housing as set forth in claim 2, wherein both of said lower tub and said upper cover are comprised of aluminum.

5. The battery housing as set forth in claim 1, further comprising:
said lower tub including a base surface and a lower sidewall extending upwardly from said base surface;
said upper cover including a top surface and an upper sidewall extending downwardly from said top surface;
a lower rim extending outwardly from said lower sidewall and an upper rim extending outwardly from said upper sidewall in overlaying relationship with said lower rim; and
a seal disposed between said upper rim and said lower rim to establish a sealed relationship between said upper cover and said lower tub.

6. The battery housing as set forth in claim 5, further comprising:
said lower rim defining a plurality of lower apertures disposed in spaced relationship with one another;
said upper rim defining a plurality of upper apertures disposed in spaced relationship with one another and each disposed in aligned relationship with a respective one of said plurality of lower apertures; and
a plurality of rim fasteners each passing through and secured to a respective pair of said aligned lower and upper apertures to secure said upper cover to said lower tub and enclose said at least one battery module within said internal cavity.

7. The battery housing as set forth in claim 6, further comprising:
said at least one battery module including a plurality of battery modules disposed in said internal cavity; and
a plurality of cross members disposed inside said internal cavity and extending transversely between opposing sides of said lower and upper sidewalls.

8. The battery housing as set forth in claim 7, wherein said plurality of cross members having a U-shaped cross-section to define a base portion disposed adjacent said base surface of said lower tub and a flanged portion disposed in abutting and underlying relationship with said top surface of said upper cover.

9. The battery housing as set forth in claim 8, wherein each of said plurality of battery modules are secured to said base portion of adjacent ones of said plurality of cross members.

10. The battery housing as set forth in claim 6, further comprising:
at least one cooling plate disposed within said internal cavity and extending underneath and in contact with said at least one battery module; and
a lower tub reinforcement extending within said internal cavity and disposed between said cooling plate and said base surface of said lower tub to protect said at least one cooling plate and battery module from a lower impact.

11. The battery housing as set forth in claim 10, wherein said lower tub reinforcement is comprised of a reinforcement plate extending along said base surface of said lower tub and including a plurality of support members extending upwardly in spaced relationship with one another.

12. The battery housing as set forth in claim 11, wherein said at least one cooling plate extends along and is supported by and secured to said plurality of support members to dispose said at least one cooling plate in spaced relationship with said base surface of said lower tub.

13. The battery housing as set forth in claim 6, further comprising a frame disposed in surrounding relationship with said lower sidewall and extending underneath a portion of said base surface of said lower tub.

14. The battery housing as set forth in claim 13, wherein said frame is a one-piece stamped component.

15. The battery housing as set forth in claim 14, wherein said frame includes a lip extending underneath said lower rim and defining a plurality of lip apertures disposed in spaced relationship with one another, each of said plurality of lip apertures disposed in aligned relationship with a respective pair of said aligned lower and upper apertures, and said plurality of rim fasteners additionally passing through and secured to respective ones of said plurality of lip apertures to secure said frame to said lower tub and said upper cover.

16. The battery housing as set forth in claim 9, wherein each of said plurality of battery modules include at least one flange that extends underneath and is secured to said base portion of a respective adjacent one of said plurality of cross members.

17. The battery housing as set forth in claim 11, wherein each of said plurality of support members have an inverted U-shaped cross-section.

18. The battery housing as set forth in claim 12, wherein said cooling plate is secured to said plurality of support members via a plurality of plate fasteners.

19. The battery housing as set forth in claim 13, wherein said frame is a roll formed component.

20. The battery housing as set forth in claim 5, wherein said upper cover includes a plurality of body mounts disposed along and outwardly from said upper sidewall.
